(19) United States
(12) Patent Application Publication
(10) Pub. No.: US 2026/0093158 A1
(43) Pub. Date: Apr. 2, 2026

(54) ELECTRONIC MARKING RING

(71) Applicant: TILTA INC., Burbank, CA (US)

(72) Inventors: Long MA, Shenzhen (CN); Yaolong LUO, Shenzhen (CN); Wenping ZENG, Shenzhen (CN); Kefeng ZHOU, Shenzhen (CN)

(21) Appl. No.: 19/331,686

(22) Filed: Sep. 17, 2025

(30) Foreign Application Priority Data
Sep. 30, 2024 (CN) 2024224248987

(51) Int. Cl. G03B 13/18

(52) U.S. Cl. CPC G03B 13/18

(57) ABSTRACT

An electronic marking ring includes: a housing including a mounting space for mounting around an object, and further including a mounting chamber; an electronic marking ring main board mounted within the mounting chamber; a display screen electrically connected to the electronic marking ring main board, mounted on the housing, and exposed therefrom for displaying lens parameter data; a first connector disposed in the mounting chamber, electrically connected to the electronic marking ring main board, exposed from the housing, and configured to electrically connect to the external installation object. Compared with conventional solutions, the electronic marking ring of the present disclosure can connect to the control board of the handwheel via the first connector, receive lens parameter data from the handwheel, and display the data on the display screen. This facilitates the marking of lens parameters and simplifies parameter adjustment during shooting.

### CROSS-REFERENCE TO RELATED APPLICATIONS

The present application for patent claims priority to and the benefit of pending Chinese Application No. 2024224248987, filed on Sep. 30, 2024, and hereby expressly incorporated by reference herein as if fully set forth below in its entirety and for all applicable purposes.

### TECHNICAL FIELD

The present disclosure pertains to the field of photographic auxiliary equipment, especially to an electronic marking ring.

### INTRODUCTION

During shooting, camera users often require different lens parameters—such as zoom, focus, and aperture—for different compositions, necessitating rotational adjustment of the lens to achieve the desired image. To facilitate such adjustments, follow focus systems have been developed, which typically include a main unit and a handwheel. The handwheel is often equipped with a white ring or the like that allows users to manually mark parameter settings for reference to adjust the lens during shooting. However, manually marking parameters on a white ring can be inconvenient for some users, which may negatively impact the shooting performance and experience.

### BRIEF SUMMARY

Aspects the present disclosure is to provide an electronic marking ring that facilitates the marking of lens parameters and simplifies lens parameter adjustment.

To achieve the above objective, the technical solution of the present disclosure is as follows:

The present disclosure provides an electronic marking ring, including:
a housing including a mounting space for sleeving onto an object to be mounted, wherein the housing further includes a mounting chamber;
an electronic marking ring main board mounted in the mounting chamber;
a display screen electrically connected to the electronic marking ring main board, mounted on the housing, and exposed therefrom for displaying lens parameter data;
a first connector disposed in the mounting chamber and electrically connected to the electronic marking ring main board, exposed from the housing, and configured to electrically connect to the object to be mounted.

Compared with the existing technology, the electronic marking ring of the present disclosure can connect to the control board of the handwheel via the first connector, receive lens parameter data from the handwheel, and display the data on the display screen. This allows users to monitor changes in lens parameters in real time and facilitates easier adjustment of lens parameters.

### BRIEF DESCRIPTION OF THE DRAWINGS

To further illustrate various aspects of the present disclosure, the following provides a brief description of the accompanying drawings for implementing exemplary embodiments of the present disclosure. The drawings illustrate exemplary embodiments of the present disclosure, and other derived configurations may be obtained by those skilled in the art without departing from the spirit and scope of the disclosure.

FIG. 1 is a diagram illustrating a follow focus unit according to some aspects of the disclosure.

FIG. 2 is a diagram illustrating a handwheel according to some aspects of the disclosure.

FIG. 3 is a diagram illustrating an exploded view of the handwheel according to some aspects of the disclosure.

FIG. 4 is a diagram illustrating an electronic marking ring according to some aspects of the disclosure.

FIG. 5 is a diagram illustrating an exploded view of an electronic marking ring according to some aspects of the disclosure.

FIG. 6 is a diagram illustrating a first shell according to some aspects of the disclosure.

FIG. 7 is a diagram illustrating a second shell according to some aspects of the disclosure.

FIG. 8 is a diagram illustrating an assembly state of the second shell and an electronic marking ring main board according to some aspects of the disclosure.

FIG. 9 is a diagram illustrating a lens adjustment device without the electronic marking ring installed according to some aspects of the disclosure.

FIG. 10 is a diagram illustrating the electronic marking ring according to some aspects of the disclosure.

### REFERENCE NUMERALS

1. follow focus unit; 2. handwheel; 21. fixed part; 211. second slot; 212. second magnetic member; 213. positioning hole; 214. limiting member; 2141. first limiting member; 2142. second limiting member; 215. receiving slot; 216. spring; 22. rotating part; 221. mounting position; 222. detent ball; 23. handwheel control board; 24. second connector; 25. electronic marking ring; 250. mounting space; 251. housing; 2511. first shell; 2512. second shell; 2513. first shell plate; 2514. second shell plate; 2515. first limiting protrusion; 2516. second limiting protrusion; 25110. third limiting protrusion; 2517. exposure hole; 2518. supporting step; 2519. pressing step; 2510. pressing location; 252. first connector; 253. mounting chamber; 254. first slot; 255. electronic marking ring main board; 2551. flex cable; 2552. first end; 2553. second end; 2554. third end; 2555. fourth end; 256. display screen; 257. first magnetic member; 258. mounting slot; 259. mounting protrusion; 26. positioning protrusion.

### DETAILED DESCRIPTION

To clarify the various aspects of the present disclosure, the following description is provided with reference to the accompanying drawings and illustrative examples. It should be understood that the specific embodiments described herein are provided for the purpose of illustration and are not intended to limit the scope of the present disclosure.

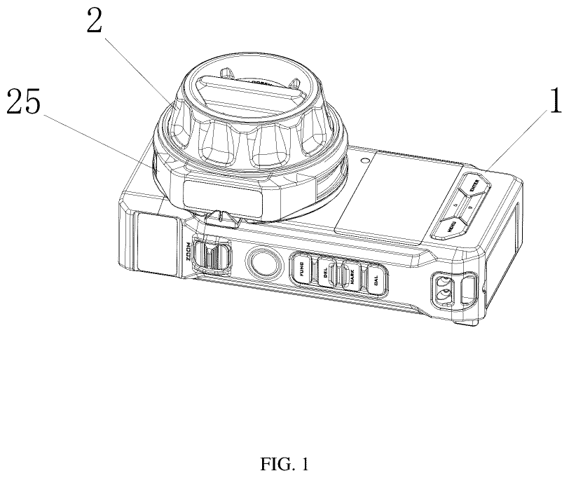

As shown in FIG. 1, a lens adjustment device (e.g., a follow focus unit) includes: a follow focus unit 1 and a handwheel 2, wherein the follow focus unit 1 is in communication with the handwheel 2. When adjusting photographic equipment during shooting, the follow focus unit 1 drives the lens of the photographic equipment by rotating the handwheel 2, thereby adjusting lens parameters such as focus, focal length, and aperture.

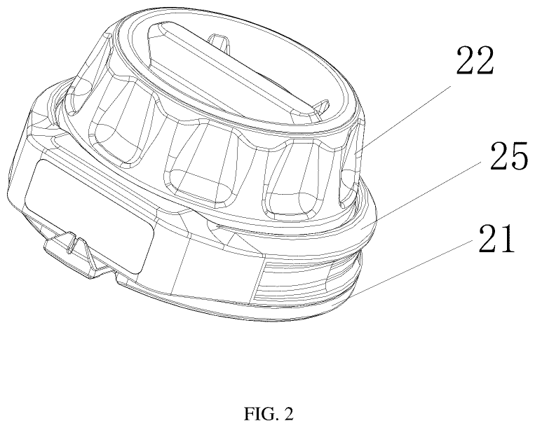

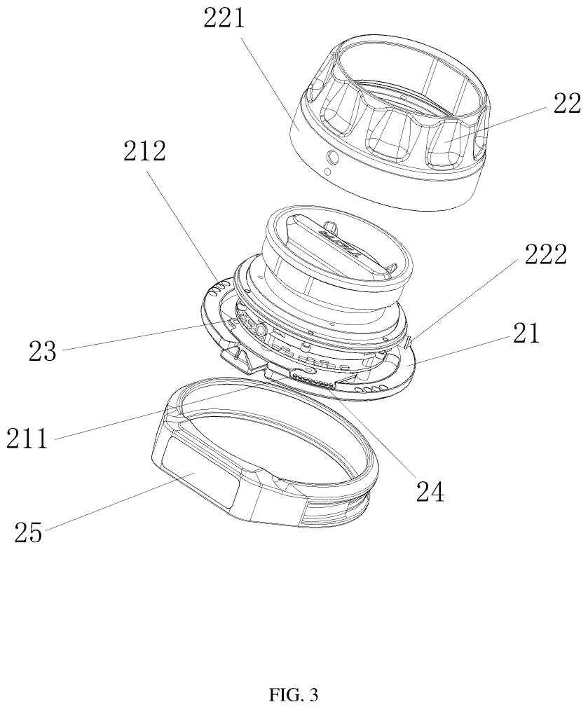

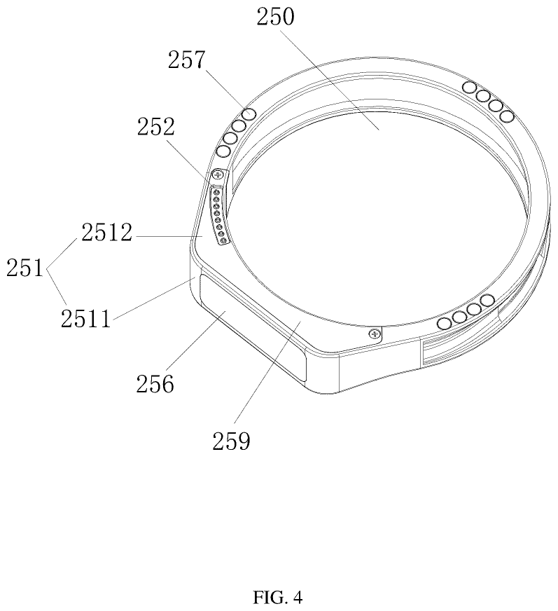

Referring to FIGS. 2-3, in some aspects, the handwheel 2 includes: a fixed part 21, a rotating part 22, a handwheel control board 23, a second connector 24, and an electronic marking ring 25. The rotating part 22 is rotatably connected to the fixed part 21. The handwheel control board 23 is connected to the fixed part 21. The fixed part 21 has a second slot 211. The second connector 24 is electrically connected to the handwheel control board 23 and is exposed through the second slot 211 on a side of the fixed part 21 facing the rotating part 22. The electronic marking ring 25 has a mounting space 250 and a first connector 252 (see FIG. 4). The rotating part 22 is at least partially mounted in the mounting space 250 such that the first connector 252 and the second connector 24 are electrically connected. The fixed part 21 is mounted on the follow focus unit 1. During use, the user can hold the follow focus unit 1 for convenient operation.

In some aspects, the handwheel 2 can serve as the external installation object and is used for mounting the electronic marking ring 25. The rotating part 22 has a mounting position 221 adapted to the mounting space 250. In some aspects, the mounting position 221 is annular, and the mounting space 250 is generally annular in shape. The electronic marking ring 25 is sleeved onto the mounting position 221 of the rotating part 22 via the mounting space 250. In some embodiments, the mounting position 221 and the mounting space 250 can also be configured in other shapes.

The mounting position 221 is a universal structure. Conventional white rings also have a mounting space 250 matching the mounting position 221. In practice, either a white ring or the electronic marking ring 25 can be selected for installation, providing flexibility for users. The white ring is a marking disk that is usually made of white plastic. Cinematographers or videographers use it to draw focus marks with an erasable marker or grease pencil—for example, marking where the lens is sharp on a subject at certain distances.

When using a white ring, parameters must be manually written on the ring to indicate specific values of the current lens parameters. While this allows users to mark parameters according to their shooting habits, manual marking is relatively time-consuming and labor-intensive. Moreover, manually marked parameter values can deviate from the actual values of the camera, which can affect shooting quality.

When using the electronic marking ring 25, the electrical connection between the first connector 252 and the second connector 24 enables communication between the electronic marking ring 25 and the handwheel control board 23. When parameters are adjusted by rotating the rotating part 22, the handwheel control board 23 can feed back the current lens parameter values to the electronic marking ring 25. This allows the electronic marking ring 25 to automatically display the specific values of the current lens parameters, enabling users to monitor changes in lens parameters in real time and facilitating adjustment to the desired values.

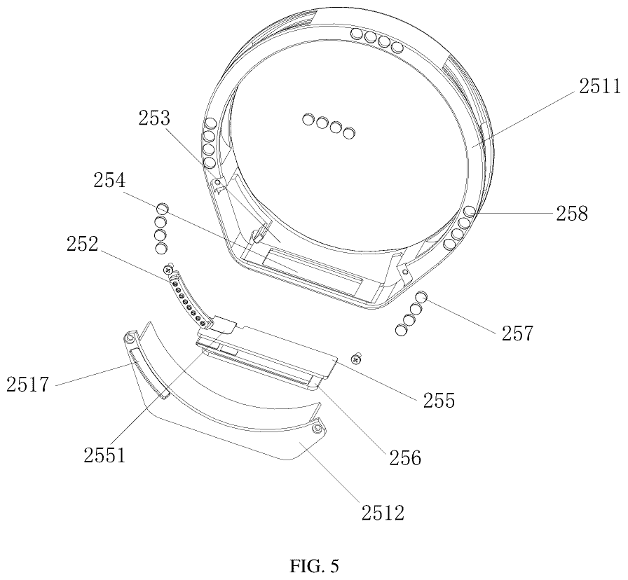

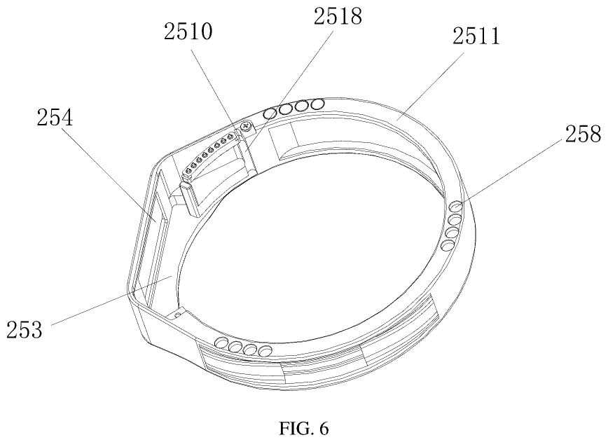

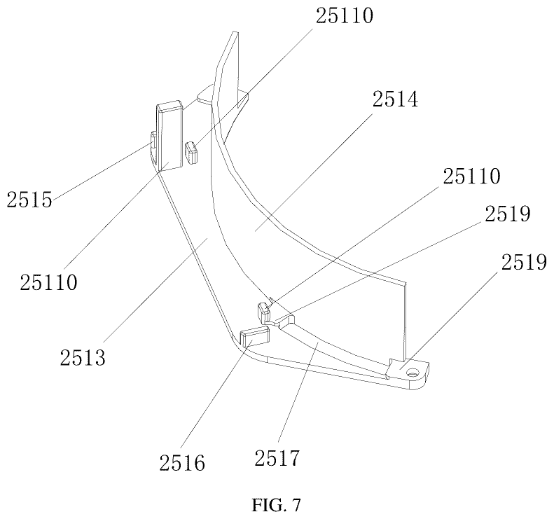

Referring to FIGS. 3-8, in some aspects, the electronic marking ring 25 includes: a housing 251, an electronic marking ring main board 255, a display screen 256, and a first connector 252.

The housing 251 includes a mounting space 250 for sleeving onto an external installation object, for example the handwheel 2. The housing 251 further includes a mounting chamber 253 and a first slot 254, wherein the first slot 254 communicates with the mounting chamber 253. The electronic marking ring main board 255 is mounted in the mounting chamber 253. The display screen 256 is connected to the electronic marking ring main board 255 and mounted in the first slot 254 such that it is exposed from the housing 251, for displaying lens parameter data. The first connector 252 is disposed in the mounting chamber 253 and connected to the electronic marking ring main board 255, and is exposed from the housing 251 for electrically connecting to the handwheel 2.

The housing 251 is sleeved onto the mounting position 221 of the rotating part 22 of the handwheel 2 via the mounting space 250. The electronic marking ring main board 255 communicates with the handwheel control board 23 via the first connector 252, receives the current lens parameter values via the handwheel control board 23, and displays them on the display screen 256, thereby facilitating the marking of lens parameters and simplifying parameter adjustment.

In some aspects, the first connector 252 can include at least one of an electronic contact pin, a socket, or an interface. In some aspects, the first connector 252 is an electronic contact pin, such as a pogo pin, and the second connector 24 is a conductive column adapted to the electronic contact pin. The electronic contact pin and the conductive column are connected via contact, which eliminates the need for plugging and unplugging compared to conventional electrical connection interfaces, making operation more effortless and convenient.

In some aspects, an outer side wall of the housing 251 can be provided with a first magnetic member 257 for positioning and mounting the electronic marking ring 25 onto the handwheel 2. A plurality of mounting slots 258 are uniformly distributed on the outer side wall of the housing 251. A plurality of first magnetic members 257 are provided, each disposed within one of the mounting slots 258. A side of the fixed part 21 facing the rotating part 22 can be provided with a second magnetic member 212. A side of the housing 251 facing the fixed part 21 can be provided with the first magnetic member 257, and the first magnetic member 257 is capable of being magnetically attracted to the second magnetic member 212. This structural design enables the electronic marking ring 25 to be positioned at the mounting position 221 through magnetic attraction between the first magnetic member 257 and the second magnetic member 212 during installation. This ensures both quick installation and accurate positioning of the electronic marking ring 25. In some aspects, the plurality of first magnetic members 257 can be symmetrically distributed on the outer periphery of the side of the housing 251 facing the fixed part 21 to improve installation stability. For example, three, four, five, or more first magnetic members 257 can be symmetrically arranged on the outer periphery of the side of the housing 251 facing the fixed part 21.

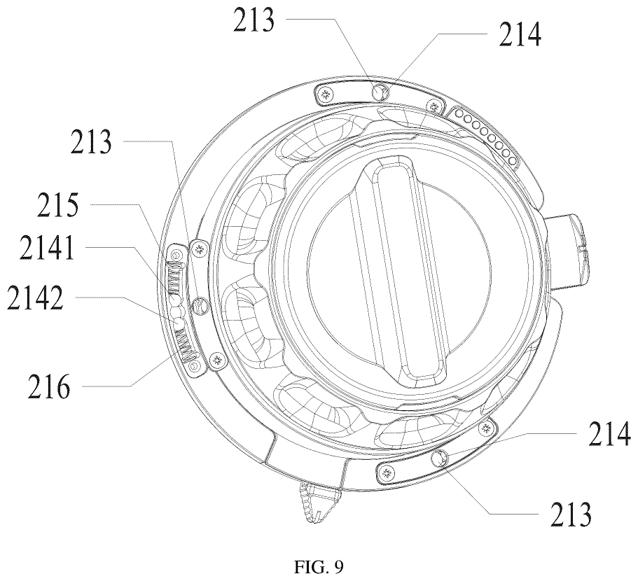

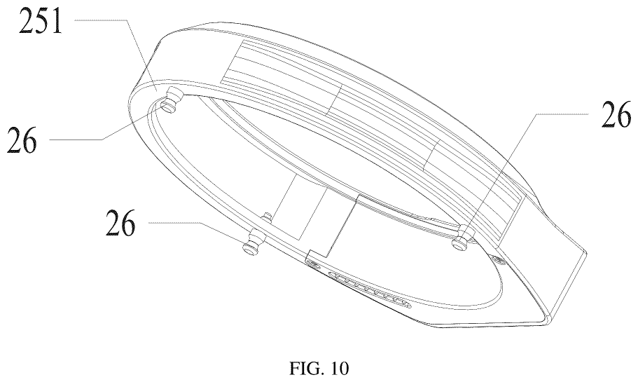

In some aspects, referring to FIGS. 9-10, in some aspects, one of the outer wall of the housing 251 and the fixed part 21 can be provided with a positioning protrusion 26, and the other is elastically provided with a limiting member 214 and a positioning hole 213. The positioning protrusion 26 is capable of being inserted into the positioning hole 213, and the limiting member 214 is capable of retaining the positioning protrusion 26 within the positioning hole 213. Installation and positioning between the housing 251 and the handwheel 2 are achieved this way. In some aspects, the fixed part 21 can be provided with a receiving slot 215. The limiting member 214 includes a first limiting member 2141 and a second limiting member 2142. The first limiting member 2141 and the second limiting member 2142 can be elastically connected within the receiving slot 215 via a spring 216. The first limiting member 2141 and the second limiting member 2142 are oppositely disposed. When installing the electronic marking ring 25, inserting the positioning protrusion 26 into the positioning hole 213 causes the first limiting member 2141 and the second limiting member 2142 to be forced apart and then reset (e.g., by a spring), thereby retaining the positioning protrusion 26. It is worth noting that the installation positions of the positioning protrusion 26 and the first limiting member 2141 can also be reversed. The working principle remains consistent with the above and will not be elaborated here.

In some aspects, the housing 251 protrudes away from the mounting space 250 to form a mounting protrusion 259. The mounting chamber 253 is located within the mounting protrusion 259. The first slot 254 is located on an outer side wall of the mounting protrusion 259. The electronic marking ring main board 255 is disposed within the mounting protrusion 259. The display screen 256 is disposed on the outer side wall of the mounting protrusion 259. One end of the first connector 252 is disposed within the mounting chamber 253 of the mounting protrusion 259, and the other end is exposed from the mounting protrusion 259. In some aspects, the mounting protrusion 259 allows the display screen 256 to protrude for better visibility. A user can hold the follow focus unit 1 with the display screen 256 facing toward the user. The extension of the mounting protrusion 259 makes the display interface of the display screen 256 easily visible, facilitating viewing of the current lens parameter values.

In some aspects, an outer periphery of the rotating part 22 is elastically provided with a plurality of detent balls 222, which facilitate rotation of the rotating part 22 relative to the electronic marking ring 25. In some aspects, an inner side wall of the housing 251 can be provided with a clearance groove that extends toward the mounting protrusion 259 via an inclined surface. When the user rotates the rotating part 22, the detent balls 222 gradually abut against the inclined surface and the inner side surface of the mounting protrusion 259. The detent balls 222 thereby facilitate smooth rotation of the rotating part 22 relative to the inner side surface of the mounting protrusion 259 of the electronic marking ring 25.

In some aspects, the housing 251 includes a first shell 2511 and a second shell 2512. The first shell 2511 and the second shell 2512 can be connected by screws. In some aspects, they can also be fixed with adhesive or configured as a detachable connection. The first shell 2511 protrudes outward away from the mounting space 250 and cooperates with the second shell 2512 to form the mounting protrusion 259. The mounting chamber 253 is formed between the first shell 2511 and the second shell 2512. One end of the first connector 252 is connected to the electronic marking ring main board 255, and the other end passes through and is exposed outside the second shell 2512. The first slot 254 can be provided on an outer side wall of the first shell 2511. This structural design allows the housing 251 to be detachable. Components disposed within the mounting chamber 253, such as the electronic marking ring main board 255 and the first connector 252, are thereby easily assembled and disassembled, facilitating replacement and maintenance.

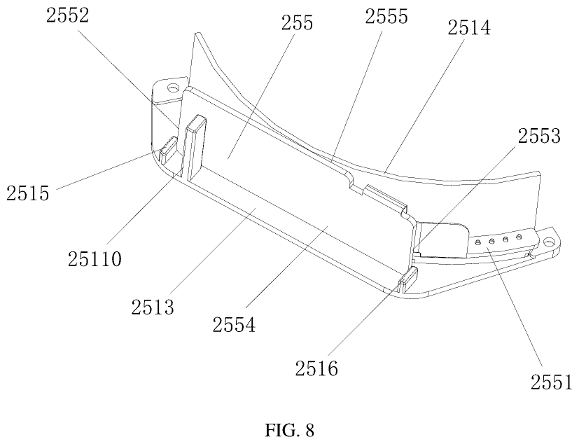

In some aspects, referring to FIG. 8, the second shell 2512 includes a first shell plate 2513 and a second shell plate 2514. The electronic marking ring main board 255 includes oppositely disposed first end 2552, second end 2553, third end 2554, and fourth end 2555. The first end 2552 and the second end 2553 are oppositely disposed; the third end 2554 and the fourth end 2555 are also oppositely disposed. The first shell plate 2513 includes a first limiting protrusion 2515 and a second limiting protrusion 2516 for limiting the position of the first end 2552 and the second end 2553, respectively. The second shell plate 2514 is connected to the first shell plate 2513. The first shell plate 2513 is further provided with a third limiting protrusion 25110. The third limiting protrusion 25110 and the second shell plate 2514 are positioned at the third end 2554 and the fourth end 2555 of the electronic marking ring main board 255, respectively, for limiting the third end 2554 and the fourth end 2555. Through this arrangement, the electronic marking ring main board 255 is constrained in two directions, thereby achieving limitation along two mutually perpendicular axes. This improves structural stability and ensures normal operation of the electronic marking ring.

In some aspects, the electronic marking ring main board 255 is a printed circuit board (PCB).

In some aspects, the electronic marking ring main board 255 is further provided with a flex cable 2551. The first connector 252 can be connected to the electronic marking ring main board 255 via the flex cable 2551.

In some aspects, the second shell 2512 can be provided with an exposure hole 2517 that communicates with the mounting chamber 253. The exposure hole 2517 is located on the first shell plate 2513. One end of the first connector 252 passes through the exposure hole 2517 and is exposed outside the second shell 2512.

In some aspects, the first shell 2511 can be provided with a supporting step 2518. The second shell 2512 can be provided with a pressing step 2519 positioned above the supporting step 2518. A pressing location 2510 is formed between the supporting step 2518 and the pressing step 2519. The first connector 252 is pressing against the pressing location 2510. This structural design enables the first connector 252 to be pressed and secured between the first shell 2511 and the second shell 2512, thereby preventing loosening and ensuring a stable electrical connection with the second connector 24.

In some aspects, there are two supporting steps 2518. Correspondingly, two pressing steps 2519 are provided. The two pressing steps 2519 are located directly above the two supporting steps 2518, respectively, in a one-to-one correspondence. Both ends of the first connector 252 are disposed between the supporting steps 2518 and the pressing steps 2519, allowing simultaneous support at both ends of the first connector 252 and further improving structural stability.

What is claimed is:

1. An electronic marking ring, comprising:
a housing comprising a mounting chamber and a mounting space for sleeving onto an external installation object;
an electronic marking ring main board mounted in the mounting chamber;
a display screen electrically connected to the electronic marking ring main board, mounted on the housing, and configured to expose from the housing, for displaying lens parameter data; and
a first connector provided in the mounting chamber and electrically connected to the electronic marking ring main board, and configured to be exposed from the housing, for electrically connecting to the external installation object.

2. The electronic marking ring according to claim 1, wherein an outer side wall of the housing is provided with a first magnetic member for positioning and mounting the electronic marking ring to the external installation object.

3. The electronic marking ring according to claim 2, wherein one or more mounting slots are uniformly distributed on the outer side wall of the housing; and
wherein the first magnetic member comprises one or more first magnetic members that are correspondingly disposed in the one or more mounting slots.

4. The electronic marking ring according to claim 1, wherein an outer side wall of the housing is provided with one or more positioning protrusion for positioning and mounting the electronic marking ring to the external installation object.

5. The electronic marking ring according to claim 1, wherein the housing protrudes away from the mounting space to form a mounting protrusion;
wherein the mounting chamber is located in the mounting protrusion;
wherein an outer side wall of the mounting protrusion is provided with a first slot;
wherein the display screen is disposed in the first slot of the mounting protrusion; and
wherein one end of the first connector is disposed in the mounting protrusion, and another end is exposed from the mounting protrusion.

6. The electronic marking ring according to claim 5, wherein the housing comprises a first shell and a second shell, the first shell is connected to the second shell, and the first shell protrudes outward away from the mounting space and cooperates with the second shell to form the mounting protrusion;
wherein the mounting chamber is formed between the first shell and the second shell;
wherein one end of the first connector is configured to pass through and be exposed outside the second shell; and
wherein the first slot is provided on an outer side wall of the first shell.

7. The electronic marking ring according to claim 6, wherein the second shell comprises a first shell plate and a second shell plate;
wherein the electronic marking ring main board comprises a first end, a second end, a third end, and a fourth end;
wherein the first end and the second end are oppositely disposed;
wherein the third end and the fourth end are oppositely disposed;
wherein the first shell plate comprises a first limiting protrusion and a second limiting protrusion, for limiting the first end and the second end; and
wherein the second shell plate is connected to the first shell plate, the first shell plate is further provided with a third limiting protrusion, and the third limiting protrusion and the second shell plate are respectively located at the third end and the fourth end of the electronic marking ring main board for limiting the third end and the fourth end.

8. The electronic marking ring according to claim 7, wherein the electronic marking ring main board is further provided with a flex cable, and the first connector is connected to the electronic marking ring main board through the flex cable; and
wherein the second shell is provided with an exposure hole communicating with the mounting chamber, and one end of the first connector is configured to pass through the exposure hole and expose outside the second shell.

9. A lens adjustment device, comprising a fixed part, a rotating part, a handwheel control board, a second connector, and the electronic marking ring according to claim 1;
wherein the rotating part is rotatably connected to the fixed part;
wherein the handwheel control board is connected to the fixed part;
wherein the fixed part is provided with a second slot;
wherein the second connector is electrically connected to the handwheel control board and is exposed through the second slot on a side of the fixed part facing the rotating part; and
wherein the rotating part is configured to be mounted in the mounting space, enabling the first connector and the second connector to be electrically connected.

10. The lens adjustment device according to claim 9, wherein a side of the fixed part facing the rotating part is further provided with a second magnetic member;
wherein an outer wall of the housing is provided with a first magnetic member, and the first magnetic member is configured to be magnetically attracted to the second magnetic member.

11. The lens adjustment device according to claim 9, wherein one of the outer wall of the housing and the fixed part is provided with a positioning protrusion, and another of the outer wall of the housing and the fixed part is elastically provided with a limiting member and is provided with a positioning hole; and
wherein the positioning hole is configured to receive the positioning protrusion, and the limiting member is configured to retain the positioning protrusion in the positioning hole.

12. The lens adjustment device according to claim 9, wherein an outer periphery of the rotating part is elastically provided with multiple detent balls.
